(19) United States
(12) Patent Application Publication
(10) Pub. No.: US 2025/0108454 A1
(43) Pub. Date: Apr. 3, 2025

(54) Forge Bonding Machine

(71) Applicants: DENGENSHA TOA CO., LTD., Kawasaki-shi (JP); TOYAMA PREFECTURE, Toyama-shi (JP)

(72) Inventors: Yasukazu HISADA, Konan-shi (JP); Takuya OTUBO, Konan-shi (JP); Noburo OMORI, Kawasaki-shi (JP); Hideki YAMAGISHI, Takaoka-shi (JP)

(21) Appl. No.: 18/979,849

(22) Filed: Dec. 13, 2024

Related U.S. Application Data
(63) Continuation of application No. PCT/JP2023/024122, filed on Jun. 29, 2023.

(30) Foreign Application Priority Data
Jul. 5, 2022 (JP) 2022-108674

(51) Int. Cl. B23K 20/02; B21J 5/06

(52) U.S. Cl. CPC B23K 20/023; B21J 5/06

(57) ABSTRACT

A forge bonding machine includes: a supporting body supporting a lower-surface side of bonding portion of members to be bonded in a state where the members are layered; a pressurizing body applying pressure on an upper-surface side of the bonding portion in the state where the members are layered; a stroke controller controlling a gap between the supporting and the pressurizing bodies; and a heater raising a temperature of the bonding portion to a predetermined temperature range by directly or indirectly coming into contact with the members, in which the stroke controller controls a reduction ratio R (T₀/T₁) that represents a ratio of a thickness T₀ of the bonding portion before bonding to a thickness T₁ after the bonding, and the supporting body or/and the pressurizing body comprise a rod controlled in terms of stroke toward the bonding portions by a displacement meter or a stopper.

### CROSS REFERENCE TO RELATED APPLICATIONS

This application is a continuation of International Patent Application No. PCT/JP2023/024122, having an international filing date of Jun. 29, 2023, which designated the United States, the entirety of which is incorporated herein by reference. Japanese Patent Application No. 2022-108674 filed on Jul. 5, 2022 is also incorporated herein by reference in its entirety.

### BACKGROUND OF THE INVENTION

The present invention relates to a forge bonding machine used for bonding of similar or dissimilar metal materials.

With the rapid progress in mobility electrification, there is an increasing need for utilization of aluminum (Al) and aluminum alloys being light in weight and resistant to corrosion, and also having excellent functionality such as electrical and thermal conductivities.

Particularly important combinations for vehicle bodies include similar material bonding (Al/Al) of aluminum alloys and dissimilar material bonding (Fe/Al) of an aluminum alloy and a steel (Fe). In the field of electrical equipment such as batteries and motors, bonding of Al/AI, Al/copper (Cu), Fe/Al, titanium (Ti)/Al, nickel (Ni)/Al, or the like is needed mainly for use in electrodes (terminals).

For example, lithium ion secondary batteries (LIB) used for electric vehicles due to its high output power are composed of a great number of cells, and in the case of pouch-type cells, it is required to bond together a plurality of film-like tab leads made of Al (positive electrode) and Cu (negative electrode) layered on one another (similar material bonding for parallel cases, and dissimilar material bonding for series cases).

As a technique for bonding metal materials, various working methods have conventionally been employed.

Examples include laser welding in which laser light is used for welding, resistance spot welding in which the electrical resistance of layered portions of metal materials is utilized to generate heat by electrical energization so that welding is achieved. In such welding methods, however, since the bonding portion is heated to a high temperature corresponding to the melting temperature, a fragile intermetallic compound (IMC) is readily generated in the bonding portion in many cases of dissimilar metal welding, and therefore there is a critical problem from the perspective of the material science, that is, practical bonding strength is not efficiently achieved.

In addition, such a melt welding method causes the portions to be melted around the welding portion to be subjected to the high temperature as well and imposes a considerable thermal influence thereon, leading to reduction in strength of the materials and poor stability in strength of the joint.

Furthermore, the melt welding methods involve a concern about deterioration in functionality including the strength and electrical performance of the bonding portion caused by deterioration in cleanliness of the surface of the welding portion due to sputtering, and the porosity due to a metal vapor generated at the time of melting, the air, and a shielding gas.

For example, in the case where the laser welding or resistance spot welding being one of the melt welding methods is employed for connection of layered electrodes (tab leads) composed of layered foils, a short circuit due to sputtering or connection failure due to a blowhole may occur even in the case of similar material bonding.

In the case of bonding dissimilar vehicle-structural materials or panel materials, it is difficult to achieve bonding exhibiting a practical strength, due to IMC as described earlier.

As to the case of solid-phase bonding, ultrasonic bonding necessitates horns that are expendable and expensive, and readily causes a burr or contamination at the bonding portion, and friction stir welding (FSW) of utilizing frictional heat accompanies an effortful work of treating the starting end and finishing end of the bonding portion.

For example, although Patent Document JP-A-2004-71199 and Patent Document JP-A-2004-273178 disclose crimp-bonding in which layered electrodes are press-bonded by a clamping plate or a plate member, the crimp-bonding is not metallurgical bonding, and therefore tends to be unsatisfactory in bonding quality and is not suitable for bonding of panel materials.

### BRIEF DESCRIPTION OF THE DRAWINGS

FIGS. 1A-1C schematically illustrate a configuration of a forge bonding machine according to the invention, and FIG. 1A illustrates a cross-sectional view, FIG. 1B illustrates a cross-sectional view of an operation at the time of bonding, and FIG. 1C illustrates a cross-sectional view of a configuration example in which the rods each have a relief portion.

FIGS. 2A-2B illustrate a forge bonding example of aluminum alloy panel materials, and FIG. 2A illustrates an external appearance of bonding portion (digital microscopic photographs) and FIG. 2B illustrates an image quality (IQ)+inverse pole figure (IPF) map of the cross section of the bonding portion obtained by electron backscatter diffraction (EBSD).

FIG. 3 illustrates an influence of the reduction ratio and the bonding temperature for the bonding portion on the tensile shear load of a joint and the failure mode thereof.

FIG. 4 illustrates an influence of the reduction ratio and the bonding temperature for the bonding portion on EPMA oxygen intensity of the bonding interfaces.

FIGS. 5A-5B illustrate results of analysis of a bonding interface with EPMA, including backscattered electron images (CP) and a plane analysis for each element of Al, Fe, Si, Mn, and O, and FIG. 5A illustrates a sample obtained with a bonding temperature of 390° C. and a reduction ratio R of 1.9 and FIG. 5B illustrates a sample obtained with a bonding temperature of 390° C. and a reduction ratio R of 3.4.

FIGS. 6A-6C illustrate an example of bonding of aluminum foils layered one another, and FIG. 6A illustrates an external appearance of bonding portion (digital microscopic photograph), FIG. 6B illustrates an optical micrograph of a cross section of the bonding portion (after etching), and FIG. 6C illustrates a further enlarged view of FIG. 6B.

FIG. 7 illustrates an IQ+IPF map obtained by EBSD of the cross section of the bonding portion of the layered aluminum foils.

FIG. 8 illustrates an influence of the reduction ratio and the bonding temperature for the bonding portion of the layered aluminum foils on the tensile shear load of a joint and the failure mode thereof.

FIGS. 9A-9D illustrate an example of bonding of a cold-rolled steel sheet (SPCC) and an aluminum alloy plate (A5052), and FIG. 9A illustrates a photograph of an external appearance of a joint, FIG. 9B illustrates an optical microscopic image of the cross section of the bonding portion (macro cross section), and FIG. 9C illustrates EBSD images of a portion in the vicinity of the axial center of the cross section of the bonding portion (upper side: IQ map, lower side: IPF map), and FIG. 9D illustrates a bright field image of the bonding interface taken with a transmission electron microscope (TEM).

### DETAILED DESCRIPTION

The following disclosure provides many different embodiments, or examples, for implementing different features of the provided subject matter. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Further, when a first element is described as being “connected” or “coupled” to a second element, such description includes embodiments in which the first and second elements are directly connected or coupled to each other, and also includes embodiments in which the first and second elements are indirectly connected or coupled to each other with one or more other intervening elements in between.

In order to solve the above-described technical problems, an object of the invention is to provide a new forge bonding machine that allows for solid-phase bonding at a relatively low temperature and in a short period of time while plastic flow is generated in the bonding interface.

The forge bonding machine includes: supporting body that supports a lower-surface side of bonding portion of members to be bonded in a state where the members are layered on one another; pressurizing body that applies pressure on an upper-surface side of the bonding portion in the state where the members are layered on one another; stroke controller that controls a gap between the supporting body and the pressurizing body; and heater that rises a temperature of the bonding portion to a predetermined temperature range by directly or indirectly coming into contact with the members, in which the stroke controller controls a reduction ratio R (T₀/T₁) that represents a ratio of a thickness T₀ of the bonding portion before bonding to a thickness T₁ of the bonding portion after the bonding.

In the present specification, the one disposed on the lower-surface side of the bonding portion is expressed as the supporting body whereas the one disposed on the upper-surface side thereof is expressed as the pressurizing body for the sake of convenience, but it is sufficient that the clamping in the vertical or horizontal direction and pressurization from either side or both sides are accomplished in the state where the bonding portion of the members to be bonded are layered on one another.

In view of the fact that the bonding temperature is unstable in the case of heating by electrical energization utilizing the electrical resistance of the members to be bonded as in the conventional resistance spot welding, according to the invention, indirect heater by heat conduction for the members to be bonded is employed and the pressurization force (pressurization conditions) for the bonding portion can be regulated according to the reduction ratio R.

In the bonding machine of the invention, the principle of bonding at the bonding interface is diffusion.

In the diffusion, the state of diffusion paths greatly affects on the reaction progress.

The machine of the invention applies pressure on the bonding portion so that a contaminant layer such as oxide film on the surfaces of the members to be bonded being a factor of impeding the diffusion is extended in the in-plane direction of the bonding surface by plastic flow to be divided or extremely reduced in thickness (that is, a bonding surface being a nascent surface or approximately nascent surface exhibiting high cleanliness is generated), thereby conditioning the diffusion paths (bonding interface) to achieve efficient diffusion.

Furthermore, since the bonding temperature having dominant influence on the diffusion reaction can be regulated in a stable manner, bonding conditions necessary for achieving a proper joint are ensured (the reduction ratio and the bonding temperature serve as basic parameters for regulation of the joint strength).

In the invention, the heater may be a temperature-rising body that comes into contact with the outer circumferential portion of the bonding portion, the supporting body or/and the pressurizing body are a rod controlled in terms of stroke toward the bonding portion, and the rod controlled in terms of stroke is disposed in an insertion hole of the temperature-rising body, whereby a forge bonding machine having a simple structure and exhibiting high productivity can be achieved.

In the invention, although optimum bonding conditions vary depending on the metal material, it would be enough that the bonding portion has such a strength that achieves a base material fracture mode in the tensile shear test.

The conditions concerning the reduction ratio may be determined based on evaluation of the state of the oxide film in the bonding interface by linear analysis or plane analysis with an electron probe micro analyzer (EPMA) or the like.

The bonding temperature is roughly in the range of about 330° C. to 450° C., and the reduction ratio R is preferably 2.0 or more.

In the invention, the temperature-rising body may have a hollow (recess) for relief of the member to-be-bonded at the time of bonding, or otherwise the rod may have a step for relief of the member to-be-bonded at the time of bonding.

With the forge bonding machine according to the invention, the solid-phase bonding can be made at a lower temperature than in the case of conventional melt welding, and the bonding strength can be regulated by control of the reduction ratio, so that a stable bonding quality and high productivity can be achieved.

### DETAILED DESCRIPTION

Exemplary embodiments are described below. Note that the following exemplary embodiments do not in any way limit the scope of the content defined by the claims laid out herein. Note also that all of the elements described in the present embodiment should not necessarily be taken as essential elements.

A configuration example of a forge bonding machine according to the invention and an example of a material evaluation of a bonding portion obtained with use of the machine will be described below with reference to the drawings.

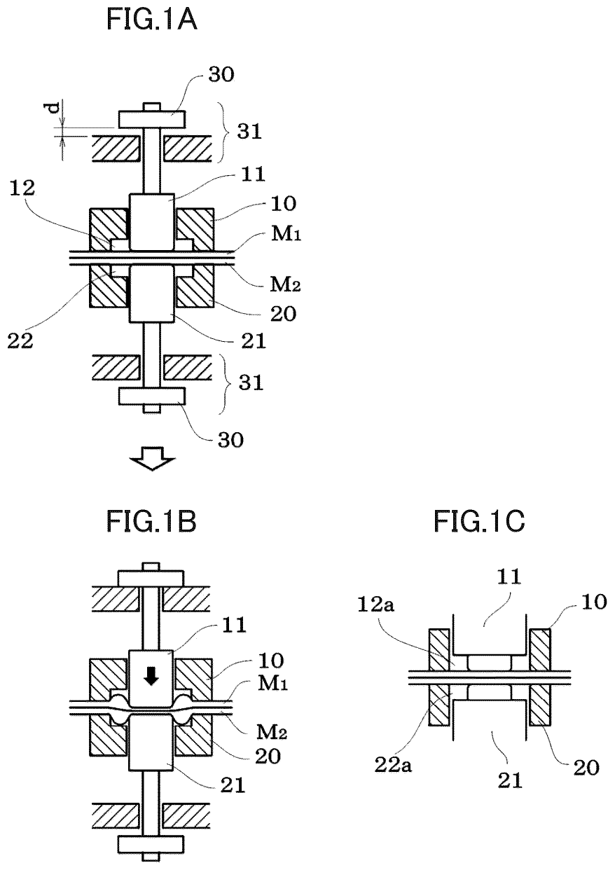

FIGS. 1A-1C schematically illustrate an example of a forge bonding machine of a double-action press type (an example used for the test and evaluation herein is illustrated).

An upper temperature-rising body 10 being vertically movable is disposed above a to-be-bonded member (metal material M₁), and has an upper rod 11 is provided so as to be vertically-movable through an insertion hole of the upper temperature-rising body 10.

A lower temperature-rising body 20 being vertically movable is disposed below a to-be-bonded member (metal material M₂), and an under rod 21 is provided through an insertion hole at the center of the lower temperature-rising body 20.

The upper rod 11 may be directly controlled in vertical movement, but in the embodiment, the upper rod 11 is pressed from above by a pressurizing punch 31 and the pressing stroke can be regulated by means of a stopper 30.

The amount of pressurizing stroke can be easily controlled by adjustment of a gap diameter d by means of the stopper 30 as described above, and hence the reduction ratio R for the bonding portion can be readily regulated.

The reduction ratio R can be also regulated based on a detected value of a load applied to the upper rod.

Otherwise, the stroke can be controlled by means of a displacement meter (encoder etc.) in the case where the rod is driven by an AC servo motor or the like.

The configuration on the side of the under rod 21 is similar to that on the side of the upper rod 11, and therefore a one-sided pressurizing operation from either side of the upper rod 11 or the under rod 21 can be made as well as a double-sided simultaneous pressurizing operation from both sides.

With the above-described configuration, an optimum pressurizing operation can be selected according to the combination of the upper and lower members to be bonded in view of the difference in plate thickness or material between the members.

FIG. 1B schematically illustrates the state where the metal materials M₁ and M₂ are layered and bonded together.

Note that FIG. 1B illustrates the state of bonding operation where the under rod 21 on the lower side is fixed and not operated and only the upper rod 11 applies pressure.

As the upper rod 11 lowers and the bonding portion is pressurized, plastic flow simultaneously occurs in the bonding interface.

This embodiment employs an example where an upper relief portion 12 of a predetermined size is formed at the lower end of the upper temperature-rising body 10 illustrated in FIG. 1A between the upper temperature-rising body 10 and the upper rod 11, and similarly, a lower relief portion 22 of a predetermined size is formed at the upper end of the lower temperature-rising body 20 between the lower temperature-rising body 20 and the under rod 21, for the purpose of facilitating the plastic flow.

The relief portion (12a, 22a) may be formed on the side of the rod as illustrated in FIG. 1C.

FIGS. 1A-1C schematically illustrate basic functions of the forge bonding machine according to the invention and hence, the drive mechanisms of the upper temperature-rising body 10, the lower temperature-rising body 20, the upper rod 11, and the under rod 21 may be designed in accordance with a publicly-known double-action press.

In the bonding method of the invention, the pressing operation is not necessarily performed from both sides, and the machine may be simplified by employing a structure where a temperature-rising body and a rod on either side are fixed.

In the case where the temperature-rising body and the rod on either side are fixed, the temperature-rising body and the rod can be integrally molded.

In addition, publicly-known heating methods and temperature control methods used for hot press may be employed to heat the upper temperature-rising body 10 and the lower temperature-rising body 20 or to control the temperature.

The rods may have a heating function in order to efficiently heat the members to be bonded.

The structure described above in which the upper temperature-rising body and rod are disposed independently from those on the lower side makes it possible to more positively heat a member having a high strength (plastic-deformation-resistant material) while the bonding temperature is set to an intended low temperature, particularly in the case of dissimilar material bonding. That is, it can be possible to introduce such a reduction ratio (plastic flow in the interface) that is appropriate for each member while the difference in plastic deformability between the members at the time of bonding is reduced (an effect of independent temperature regulation for each of the upper and lower sides). The above-described mechanism and control are particularly effective in the case of members having a difference in strength therebetween at an intended bonding temperature or having a large plate thickness.

Bonding experiments and evaluations conducted on panel materials will be described below.

Panel materials each being an aluminum alloy JIS A5052 were forge-welded together.

Two sample pieces were bonded together, each having a plate thickness t of 0.8 mm, a width W of 25 mm, and a length L of 100 mm.

A preliminary investigation was made regarding the bonding temperature.

As a result of a temperature-rising experiment conducted on temperature-rising bodies and panel materials each of which had a temperature sensor attached thereto, it was found that although certain temporal gap and difference in temperature were generated in the temperature rise of the temperature-rising bodies and the temperature rise of the bonding portion of the panel materials, the temperature of bonding portion of metal materials can be regulated by interpolating the difference.

In the following, the bonding temperature means the temperature of the bonding interface.

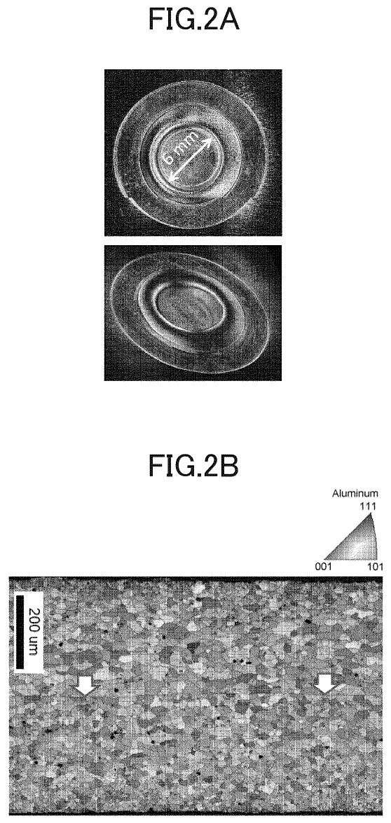

FIGS. 2A-2B illustrate an example of bonding of panel materials (plate materials) each being an aluminum alloy JIS A5052 material.

The bonding conditions of the example was as follows. That is, the rod diameter (forge bonding diameter) was 6 mm, the relief portion diameter was 9 mm, the bonding temperature was 390° C., and the reduction ratio R was 2.4.

FIG. 2A illustrates a photograph of an external appearance viewed from the pressurizing punch for the upper rod 11, and FIG. 2B illustrates an IQ+IPF map at the bonded cross section of the bonding portion obtained by EBSD.

It can be found that the bonding interface had no defect such as a crack or void and high crystallinity was exhibited, and hence favorable solid-phase bonding was achieved.

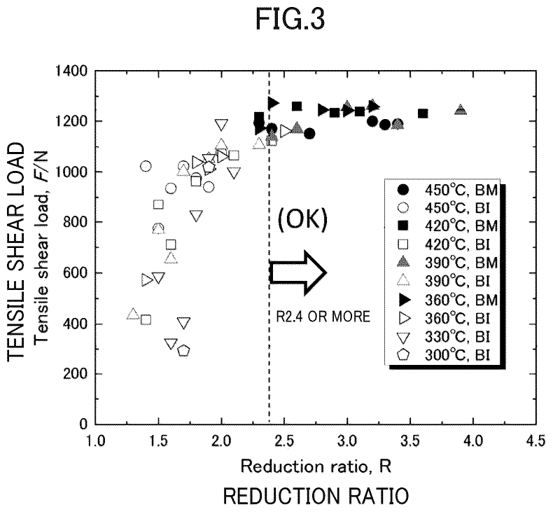

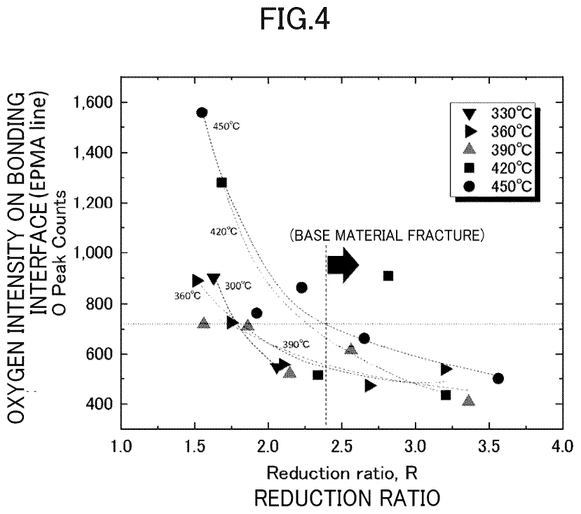

FIGS. 3 and 4 are graphs in which the bonding experiment of the aluminum alloy JIS A5052 material is presented.

FIG. 3 illustrates the tensile shear loads of the bonding portion for respective bonding temperatures obtained while the reduction ratio R was changed.

The tensile shear load was determined by applying a tensile load to the two plate materials bonded together with both ends chucked.

In the graph, BM means base material fracture, whereas BI means bonding interface fracture.

According to this experiment, it can be found that the reduction ratio R had a greater influence on the bonding strength than the bonding temperature.

It can be found that, in a bonding temperature range of 360° C. to 450° C., a proper bonding strength represented by the base material fracture can be achieved with the reduction ratio R controlled to be 2.4 or more.

FIG. 4 illustrates a result of determining the oxygen intensity (peak intensity) on the bonding interface by a linear analysis with EPMA.

It is important for stable bonding quality of the bonding portion (favorable diffusion at a low temperature in a short period of time) that the amount of contaminant layer being an impediment to diffusion in the interface is small, as described earlier.

In this regard, the oxygen peak intensity at the bonding interface was measured to monitor the contaminant layer (diffusion-impediment layer) while the reduction ratio R was changed for each bonding temperature.

As a result, although there was a tendency of the oxygen peak intensity to increase with increasing bonding temperature due to oxidation during pre-heating, it was found that the oxygen peak intensity decreased as the reduction ratio R increased due to the plastic flow generated in the bonding interface (division and reduction in thickness of the contaminant layer due to the expansion of the surface) at any one of the bonding temperatures (the effect of reduction ratio on the cleanliness of the bonding interface).

There is a tendency in forge bonding that the cleanliness of the bonding interface increases and bonding at a lower temperature is allowed as the reduction ratio increases, but according to FIG. 3, the reduction ratio R being a threshold of transition of the failure mode from BI to BM was about R2.4 almost commonly to these bonding temperatures, and thus the influence of the bonding temperature was not so significant.

With reference to the result concerning the oxygen peak intensity illustrated in FIG. 4 (the oxygen peak increased as the temperature increased) as well, it can be understood that, in the experiment concerned (the members concerned), the contaminant layer being an impediment to the diffusion and the influence of the bonding temperature being a driving force for the diffusion were almost in balance.

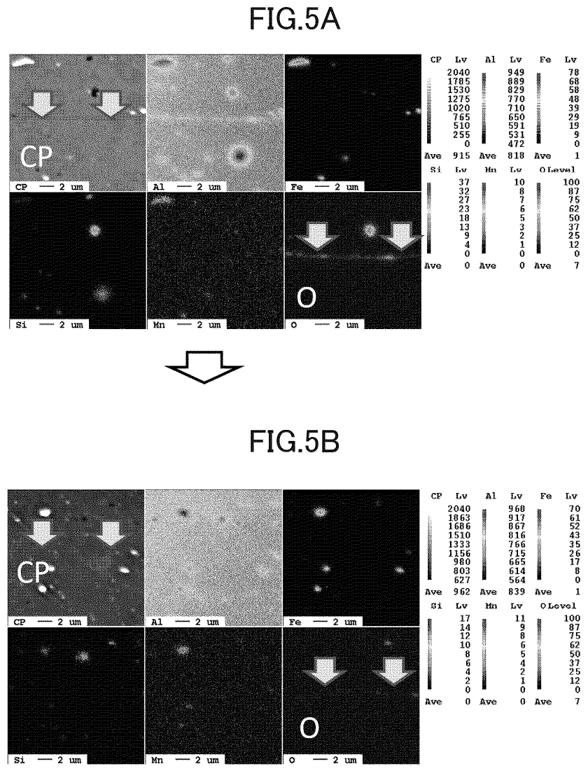

FIGS. 5A-5B illustrate the results of plane analysis with EPMA of the bonding interface performed at a bonding temperature 390° C. and FIG. 5A: a reduction ratio R of 1.9 and FIG. 5B: a reduction ratio R of 3.4.

The CP is a backscattered electron image, and the other maps each represent the result of plane analysis of a corresponding element.

As a result of tensile shear test, the interface fracture was exhibited for the case of R1.9 of FIG. 5A, while the base material fracture was exhibited for the case of R3.4 of FIG. 5B.

From the result of the analysis with EPMA, it can be found that when the reduction ratio R is increased, the contaminant layer in the bonding interface is divided or extremely reduced in thickness in appearance, so that the influence of the contaminant layer as a diffusion-impediment layer is reduced (making the contaminant layer non-impeditive), indicating that a high-quality bonding interface allowing for efficient diffusion even at a low temperature can be obtained.

By adjusting the bonding conditions (the reduction ratio and bonding temperature) in view of the above-described basic principles and behaviors, appropriate bonding conditions can be established in the bonding machine of the invention.

Next, a result of experiment will be described. In the experiment, 50 layered aluminum (JIS AlN30H) foils each having a thickness t of 0.012 mm were sandwiched and jointed by an upper aluminum plate material (JIS A1050) having a thickness t of 0.5 mm and a lower material of the same type (JIS A1050) having a thickness t of 0.8 mm.

The test piece had a width W of 30 mm and a length L of 100 mm.

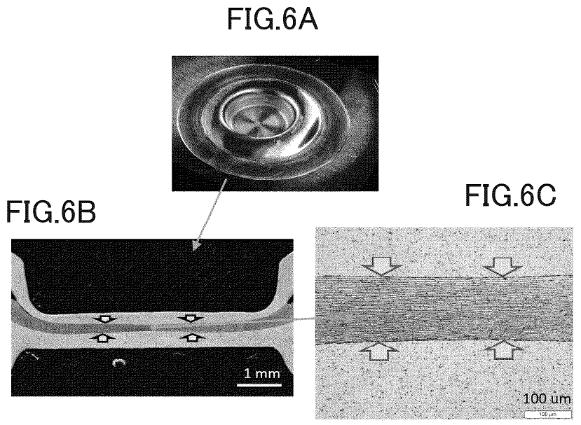

FIG. 6A is a photograph of an external appearance of the bonding portion taken with a digital microscope bonded under conditions of a bonding temperature of 420° C., a reduction ratio R of 2.4, a rod diameter of 6 mm, and a relief portion diameter of 9 mm, FIG. 6B illustrates a macro photograph of a cross section of the bonding portion (after etching) taken by an optical microscope, and FIG. 6C illustrates an enlarged view of 6B.

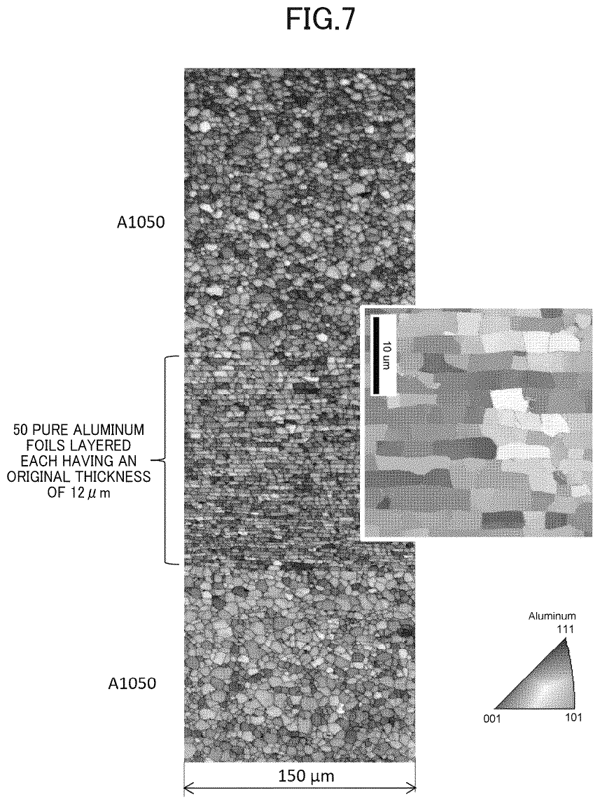

FIG. 7 illustrates an IQ+IPF map obtained by EBSD of the cross section illustrated in FIG. 6C (analyzed before etching).

The figures indicate that each of the 50 layered aluminum foils accomplished an appropriate reduction ratio without fracture, and favorable solid-phase bonding was achieved (black spots in the enlarged view are not voids but are inclusions of the material).

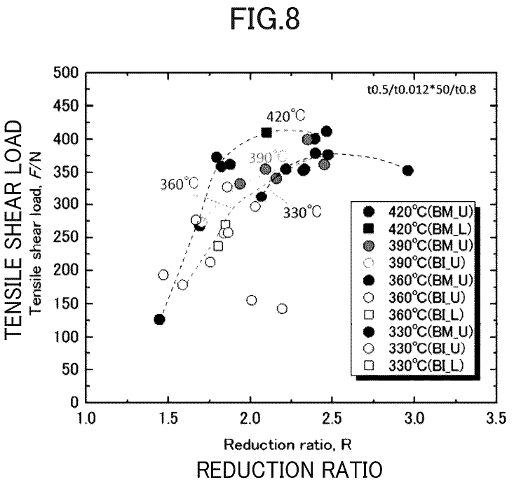

FIG. 8 illustrates the tensile shear load of the joint for each bonding temperature with respect to the reduction ratio R.

In the graph, BM_U indicates that the base material fracture occurred in the upper aluminum plate material, BM_L indicates that the base material fracture occurred in the lower aluminum plate material, and BI_U and BI_L indicate that the interface fracture occurred in the upper aluminum plate material and in the lower aluminum plate material, respectively.

Note that no peeling occurred between any foils under any conditions in the experiment.

The result indicates that the reduction ratio being a threshold of transition to the base material fracture decreases and the bonding strength increases as the bonding temperature increases. In other words, it indicates that the higher the reduction ratio introduced, the lower the temperature with which proper bonding can be achieved.

Note that it can be found that the base material fracture is accomplished with a reduction ratio of about 2.0 or more at any one of the bonding temperatures.

In view of the processing conditions under which the bonding strength is almost stable, it can be found that preferable ranges of the bonding temperature and the reduction ratio R are 330° C. or more and 2.0 or more, respectively, in the case of bonding the layered aluminum foils described above.

The following describes a result of forge bonding performed on a cold-rolled steel sheet (JIS SPCC) having a thickness t of 0.4 mm and an aluminum alloy (JIS A 5052) having a thickness t of 0.8 mm layered on one another (both having a width W of 30 mm and a length of 100 mm).

In this example, the bonding temperature was 420° C., the reduction ratio R was 3.3, the rod diameter was 3 mm, and the relief portion diameter was 10 mm.

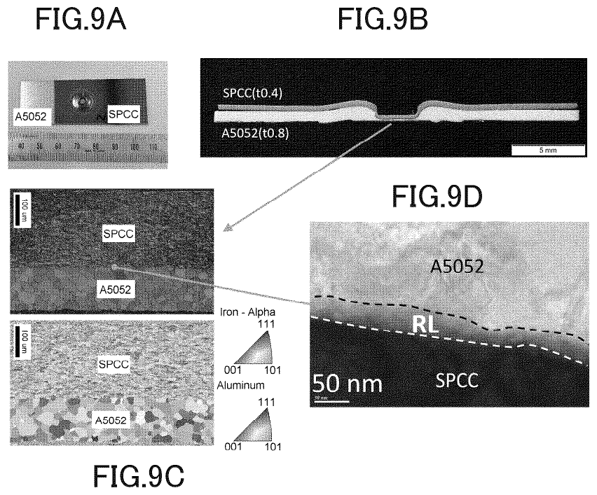

FIG. 9A illustrates an external appearance of a joint, FIG. 9B illustrates a macro cross section of the bonding portion taken with an optical microscope, FIG. 9C illustrates a result of analysis by EBSD of a portion in the vicinity of the axial center of the cross section of the bonding portion (upper side: IQ map, lower side: IPF map), and FIG. 9D illustrates a TEM bright field image of the bonding interface. The joint concerned exhibited a tensile shear load of 1,454 N and a proper failure mode, that is, the base material fracture (plug fracture). As seen from FIG. 9D, the reaction layer (RL) generated in the bonding interface had a thickness of about 20 to 50 nm, but such a thickness of IMC of Fe/Al or the like that would be generally pointed out in terms of fragility is about 1 μm, and therefore, the bonding interface concerned can be regarded as being substantially free of IMC.

In the bonding machine of the invention, although the metallurgical bonding mechanism at the interface is RL including IMC, the fragility thereof can be made non-impeditive, and therefore high-strength dissimilar material bonding can be achieved as described in the embodiment.

With the forge bonding machine according to the invention, the solid-phase bonding at a low temperature can be performed and the quality control can be achieved by controlling the bonding temperature and the reduction ratio, and therefore the forge bonding machine can be used for bonding of various kinds of metal materials.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

1. A forge bonding machine comprising:
a supporting body that supports a lower-surface side of bonding portion of members to be bonded in a state where the members are layered on one another;
a pressurizing body that applies pressure on an upper-surface side of the bonding portion in the state where the members are layered on one another;
a stroke controller that controls a gap between the supporting body and the pressurizing body; and
a heater that rises a temperature of a corresponding one of the bonding portion to a predetermined temperature range by directly or indirectly coming into contact with the members, wherein
the stroke controller controls a reduction ratio R (T₀/T₁) that represents a ratio of a thickness T₀ of the bonding portion before bonding to a thickness T₁ of the bonding portion after the bonding, and
the supporting body or/and the pressurizing body comprise a rod controlled in terms of stroke toward the bonding portions by means of a displacement meter or a stopper.

2. The forge bonding machine according to claim 1, wherein the heating body comprises a temperature-rising body that comes into contact with an outer circumferential portion of the bonding portion, and
the rod is disposed in an insertion hole of the temperature-rising body.

3. The forge bonding machine according to claim 2, wherein the temperature-rising body has a hollow for relief of the corresponding member at a time of the bonding.

4. The forge bonding machine according to claim 2, wherein the rod has a step for relief of the corresponding member at a time of the bonding.
